(19) United States
(12) Patent Application Publication
(10) Pub. No.: US 2009/0027771 A1
(43) Pub. Date: Jan. 29, 2009

(54) PROJECTION SCREEN AND METHOD OF MAKING THE SAME

(76) Inventor: David A. Champion, Lebanon, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/829,661

(22) Filed: Jul. 27, 2007

(51) Int. Cl. G03B 21/60; B05D 5/06

(52) U.S. Cl. 359/459; 427/163.3

(57) ABSTRACT

A projection screen includes a light absorbing substrate having a plurality of alternating crests and recessed portions. A light reflecting layer is established on the light absorbing substrate such that a receding portion is established on each of the recessed portions and a conformal portion is established on each of the crests. Each of the plurality of crests has a surface at which the light absorbing substrate is exposed.

### BACKGROUND

The present disclosure relates generally to projection screens and methods of making the same.

The formation of projection screens generally involves numerous process steps. For example, some processes involve the deposition and patterning of multiple optical layers in order to achieve a high optical gain surface. Multiple processing steps may be costly. Furthermore, as with many multi-step processes, the potential for contamination, defects, mechanism failure, or the like exists.

### BRIEF DESCRIPTION OF THE DRAWINGS

Features and advantages of embodiments of the present disclosure will become apparent by reference to the following detailed description and drawings, in which like reference numerals correspond to similar, through not necessarily identical, components. For the sake of brevity, reference numerals or features having a previously described function may not necessarily be described in connection with other drawings in which they appear.

FIG. 1 is a flow diagram depicting an embodiment of the method for forming an embodiment of a projection screen;

FIGS. 2A and 2B together schematically depict an embodiment of the method for forming an embodiment of the projection screen, where FIG. 2B is a cross-sectional view taken along the 2B-2B line of FIG. 3; and

FIG. 3 depicts a semi-schematic perspective view of an embodiment of the projection screen.

### DETAILED DESCRIPTION

It has been discovered that some of the techniques used in manufacturing projection screens are incompatible with some of the materials that are suitable for forming such projection screens. In fact, it has been found that some techniques may deleteriously result in the shrinking and distortion of the materials.

In contrast, embodiment(s) of the method disclosed herein advantageously reduce the number of steps often involved with forming a projection screen. It is believed that this reduction substantially minimizes material aging and the risk of material contamination. Embodiments of the projection screen are also advantageously capable of being formed without an additional protective coating and/or without an adhesive layer.

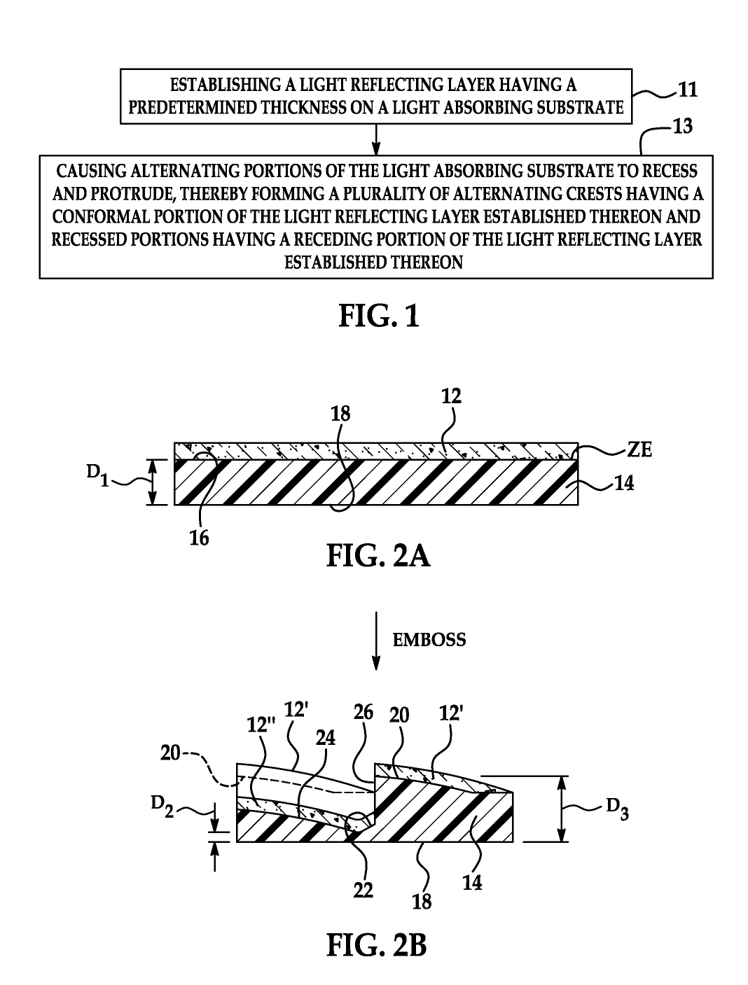

Referring now to FIG. 1, an embodiment of the method for forming an embodiment of the projection screen is shown. Generally, the method includes establishing a light reflecting layer having a predetermined thickness on a light absorbing substrate, as shown at reference numeral 11; and causing alternating portions of the light absorbing substrate to recess and protrude, thereby forming a plurality of alternating crests (having a conformal portion of the light reflecting layer established thereon) and recessed portions (having a receding portion of the light reflecting layer established thereon), as shown at reference numeral 13. After the causing step, each of the plurality of crests has a surface at which the light absorbing substrate is exposed. It is to be understood that this and other embodiments of the method and the projection screen(s) formed therefrom are described in further detail in reference to the other figures hereinbelow.

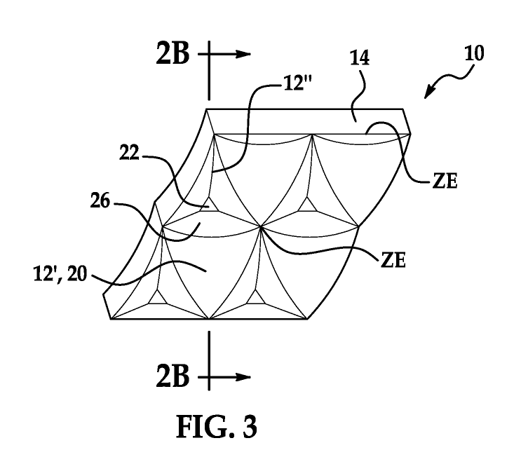

FIGS. 2A and 2B together depict schematic cross-sectional views of the method of forming an embodiment of the projection screen 10. Furthermore, FIG. 2B is a cross-sectional view of the projection screen 10 taken along the 2B-2B line of FIG. 3.

As shown in FIG. 2A, a light reflecting layer 12 is established on a light absorbing substrate 14. Non-limiting examples of the light absorbing substrate 14 includes vinyl, polyolefin, polyvinyl chloride (PVC), poly(ethylene terephthalate), or other polymeric materials that become moldable when exposed to heat. It is to be understood that the light absorbing substrate 14 may be supported (e.g., by another substrate), or may be unsupported. A non-limiting example of a supported substrate is a laminate including the light absorbing substrate 14.

As shown in FIG. 2A, the light absorbing substrate 14 has first and second opposed surfaces 16, 18, and the light reflecting layer 12 is established on one of the opposed surfaces 16, 18. Generally, prior to performing any subsequent processing steps, the first opposed surface 16 is positioned at a predetermined substantially vertical distance D₁ from the second opposed surface 18. For ease in explanation of the embodiments disclosed herein, the first opposed surface 16 of the light absorbing substrate 14 is located at an imaginary zero elevation ZE plane.

Non-limiting examples of the light reflecting layer 12 include aluminum, silver, chromium, nickel, reflective paint, and/or combinations thereof. It is to be understood that any other suitable reflective material that is capable of being embossed may also be used. Establishing the light reflecting layer 12 on the light absorbing substrate 14 may be accomplished via painting techniques (e.g., ink-jetting techniques, spray painting, doctor blading, etc.) or deposition techniques (e.g., vapor deposition). It is to be understood that while vapor deposition may be suitable in some embodiments, it may also be desirable, when using vapor deposition, to control the deposition conditions to substantially avoid substrate shrinking and/or distortion.

Generally, the light reflecting layer 12 is established to a predetermined thickness, which is relatively thin. As a non-limiting example, the thickness of the light reflecting layer 12 ranges from about 10 nm to about 5000 nm. In an embodiment in which vapor deposition is used to establish the light reflecting layer 12, the thickness of the layer 12 ranges from about 10 nm to about 120 nm. In another embodiment in which painting techniques are used to establish the light reflecting layer 12, the thickness of the layer 12 ranges from about 500 nm to about 5000 nm. Without being bound to any theory, it is believed that such thicknesses enable the reflecting layer 12 to spread and/or break when exposed to subsequent processing steps. As such, the light reflecting layer 12 conforms to some newly formed features (i.e., crests 20, shown in FIG. 2B) of the light absorbing substrate 14, and recedes with other newly formed features (i.e., recessed portions 24, shown in FIG. 2B) of the light absorbing substrate 14. It is further believed that the thickness of the light reflecting layer 12 also enables the full plasticity of the light absorbing substrate 14 to be utilized, such that the light absorbing substrate 14 may be manipulated into desirable features.

After the light reflecting layer 12 is established on the light absorbing substrate 14, the light reflecting layer 12 is caused to break at one or more areas, as shown in FIGS. 2B and 3. This may be accomplished, for example, via embossing or cutting. It is to be understood that such processes raise portions of the light absorbing substrate 14 to form crests 20, and lower alternating portions of the light absorbing substrate 14 to form recessed portions, which decline toward low points 22. The light reflecting layer 12 breaks such that portions 12′ of the layer 12 conform to the crests 20, and other portions 12″ recede with the recessed portions 24. Each crest 20 also has a surface 26 at which the light absorbing substrate 14 is exposed.

In one embodiment, an embossing mandrel (not shown) is pressed into the established light reflecting layer 12. In one embodiment of the method, a backing roller (also not shown) is exposed to the second opposed surface 18 of the light absorbing substrate 14 as the embossing mandrel is exposed to the light reflecting layer 12. The embossing mandrel and backing roller may be rotated at the same or at different angular velocities. Generally, rotating the backing roller at an angular velocity that is greater or less than that of the mandrel enables the pattern to be varied.

As previously stated, FIG. 2B schematically illustrates a cross-sectional view taken along the 2B-2B line of the projection screen 10 shown in FIG. 3. Both views illustrate the screen 10 after embossing/cutting is accomplished. As depicted, the force resulting from this process causes the light absorbing substrate 14 to recess to form recessed portions 24 and low points 22 and to rise to form crests 20. The force also forms the surfaces 26 and exposes the light absorbing substrate 14 at these surfaces 26. Still further, the force breaks the light reflecting layer 12, such that portions 12′ conform with the crests 20 and other portions 12″ conform to the recessed portions 24.

As shown in FIG. 2B, the substrate 14 is physically lowered to form the recessed portions 24 and low points 22. Since the substrate 14 is physically pressed down, the recessed portion 24, at least at the low point 22, is located at a substantially vertical distance D₂ from the second opposed surface 18 that is less than the substantially vertical predetermined distance D₁ at which the light reflecting layer 12 is originally established. In a non-limiting example, the substantially vertical distance D₂ ranges from about 40 μm to about 500 μm less than the predetermined substantially vertical distance D₁. It is to be understood that the low point 22 of the recessed portion 24 is generally located at an area that is less or lower than the zero elevation ZE plane.

Also as shown in FIG. 2B, the substrate 14 is physically raised to form crests 20. Since the substrate 14 is physically raised, at least a portion of the crest 20 (e.g., the high point) is located at a substantially vertical distance D₃ from the second opposed surface 18 that is greater than the substantially vertical predetermined distance D₁ at which the light reflecting layer 12 is originally established. It is to be understood that the high point of the crest 20 is generally located at an area that is greater or higher than the zero elevation ZE plane.

Referring now to FIGS. 2B and 3 together, the crests 20 are generally staggered with a recessed portion 24 and a low point 22 therebetween. Each crest 20 has a face that curves in three-dimensions. In one embodiment, the crest 20, at an area adjacent the surface 26, intersects the zero elevation ZE plane at about 45°. In another embodiment, the crest 20, at an area opposed to the surface 26, intersects the zero elevation ZE plane at about 22°.

The recessed portions 24 of the light absorbing substrate 14 declining toward the low point 22 generally have a face which curves in two-dimensions. The low points 22 are shown (in FIG. 3) as having a triangular shape. It is to be understood, however, that the low points 22 may have any suitable regular or non-regular geometric configuration. Some non-limiting examples include a point, a round or oblong shape, a square shape, or the like.

It is to be understood that the surface 26 at which the light absorbing substrate 14 is exposed may be substantially vertical, or may be positioned up to about 15° from normal.

An embodiment of the method of using the projection screen 10 (such as that shown in FIG. 3) involves exposing the projection screen 10 to light. It is to be understood that the light is reflected at those areas at which the light reflecting layer 12, 12′, 12″ is located. It is to be further understood that the light is absorbed at those areas at which the light absorbing substrate 14 is exposed (e.g., surface(s) 26). In one embodiment, the projection screen 10 is oriented such that unwanted light (e.g., ambient light) is directed along a first vector and is absorbed by the surface(s) 26. It is to be understood that the projection screen 10 in this embodiment is also oriented such that desirable light (e.g., projection light) is directed along a second vector and is reflected at one or more angles from the light reflecting layer 12, 12′, 12″.

While several embodiments have been described in detail, it will be apparent to those skilled in the art that the disclosed embodiments may be modified. Therefore, the foregoing description is to be considered exemplary rather than limiting.

What is claimed is:

1. A projection screen, comprising:
a light absorbing substrate having a plurality of alternating crests and recessed portions; and
a light reflecting layer established on the light absorbing substrate such that a receding portion is established on each of the recessed portions, and a conformal portion is established on each of the crests;
wherein each of the plurality of crests has a surface at which the light absorbing substrate is exposed.

2. The projection screen as defined in claim 1 wherein the light absorbing substrate is vinyl, polyolefin, polyvinyl chloride, or poly(ethylene terephthalate.

3. The projection screen as defined in claim 1 wherein the light reflecting layer is selected from aluminum, silver, chromium, nickel, reflective paint, and combinations thereof.

4. The projection screen as defined in claim 3 wherein the light reflecting layer is reflective paint and has a thickness ranging from about 500 nm to about 5000 nm.

5. The projection screen as defined in claim 3 wherein the light reflecting layer is aluminum, silver, chromium or nickel, and has a thickness ranging from about 10 nm to about 120 nm.

6. The projection screen as defined in claim 1 wherein the light absorbing substrate has first and second opposed surfaces, wherein the light reflecting layer is established on the first opposed surface, and wherein prior to formation of the crests and recessed portions, the first opposed surface is positioned at a predetermined substantially vertical distance from the second opposed surface.

7. The projection screen as defined in claim 6 wherein a low point of each recessed portion is positioned at a substantially vertical distance from the second opposed surface that is less than the predetermined substantially vertical distance.

8. The projection screen as defined in claim 6 wherein a high point of each crest is positioned at a substantially vertical distance from the second opposed surface that is greater than the predetermined substantially vertical distance.

9. The projection screen as defined in claim 1 wherein the surface at which the light absorbing substrate is a substantially vertical surface.

10. The projection screen as defined in claim 1 wherein each recessed portion declines toward a low point.

11. A method of using the projection screen as defined in claim 1, the method comprising exposing the projection screen to light, whereby the light is reflected from exposed portions of the light reflecting layer, and the light is absorbed by exposed portions of the light absorbing substrate.

12. A method of making a projection screen, the method comprising:
establishing a light reflecting layer having a predetermined thickness on a light absorbing substrate; and
causing alternating portions of the light absorbing substrate to recess and protrude, thereby forming a plurality of alternating crests having a conformal portion of the light reflecting layer established thereon and recessed portions having a receding portion of the light reflecting layer established thereon;
wherein each of the plurality of crests has a surface at which the light absorbing substrate is exposed.

13. The method as defined in claim 12 wherein establishing the light reflecting layer is accomplished by vapor deposition or painting.

14. The method as defined in claim 12 wherein causing is accomplished by exposing the light reflecting layer to an embossing mandrel.

15. The method as defined in claim 14, further comprising exposing the light absorbing substrate, at a surface opposed to a surface upon which the light reflecting layer is established, to a backing roller as the light reflecting layer is exposed to the embossing mandrel.

16. The method as defined in claim 15, further comprising rotating the embossing mandrel and the backing roller at different angular velocities.

17. The method as defined in claim 12 wherein the light absorbing substrate has first and second opposed surfaces, wherein the light reflecting layer is established on the first opposed surface, and wherein prior to causing, the first opposed surface is positioned at a predetermined substantially vertical distance from the second opposed surface.

18. The method as defined in claim 17 wherein causing results in a portion of the light absorbing substrate to lower to a substantially vertical distance from the second opposed surface that is less than the predetermined substantially vertical distance, thereby forming a low point of the recessed portion.

19. The method as defined in claim 18 wherein the substantially vertical distance from the second opposed surface ranges from about 40 μm to about 500 μm less than the predetermined substantially vertical distance.

20. The method as defined in claim 17 wherein causing results in a portion of the light absorbing substrate to raise to a substantially vertical distance from the second opposed surface that is greater than the predetermined substantially vertical distance, thereby forming a high point of the crest.
